(19) United States
(12) Patent Application Publication
(10) Pub. No.: US 2008/0287534 A1
(43) Pub. Date: Nov. 20, 2008

(54) Method for Controlling Insect Pests on Plants

(76) Inventors: Jon Stuart Claus, Wilmington, DE (US); Gale Edwin Drake, Livonia, NY (US); Robert Mark Leighty, Carney's Point, NJ (US); Frederick Walters Marmor, Litchfield, AZ (US)

Correspondence Address: Birch, Linda D.;E.I. Du Pont De Nemours and Company, Legal Patent Records Center, 4417 Lancaster Pike, Wilmington, DE, 19805, US

(21) Appl. No.: 11/883,603

(22) PCT Filed: Feb. 14, 2006
(86) PCT No.: PCT/US06/05526

§ 371 Date: Jun. 24, 2008

Related U.S. Application Data
(60) Provisional application No. 60/652,610, filed on Feb. 14, 2005.
(60) Provisional application No. 60/684,355, filed on May 25, 2005.
(60) Provisional application No. 60/689,697, filed on Jun. 10, 2005.

(51) Int. Cl. A01N 47/24; A01P 7/04

(52) U.S. Cl. 514/477

(57) ABSTRACT

Disclosed is a method for protecting a plant planted in a growing medium from foliar insect pests comprising applying an insecticidally effective amount of a mixture comprising methomyl and oxamyl to the growing medium.

### FIELD OF THE INVENTION

This invention pertains to a method for controlling insect pests afflicting plants by using mixtures of methomyl and oxamyl.

### BACKGROUND OF THE INVENTION

Insecticide applications that can be applied at as low a dose as possible and be effective in controlling pest species of insects while causing as little harm as possible to beneficial insects and minimal disturbance in the environment are in demand by the farming community. Insects are very destructive to crop plants and can result in significant loss of crop yield and quality, which results in economic loss to the grower and increased costs to the consumer. Combinations of insecticides are typically used to broaden the spectrum of insect control or enhance the level of control of any given species through additive effect. Certain rare combinations surprisingly give a greater-than-additive or synergistic effect.

Methomyl is sold by DuPont as the active ingredient in Lannate® insecticide for foliar application to control numerous insect pests of agricultural crops including, but not limited to, insects from the order Lepidoptera (e.g., corn earworm, loopers, armyworms, cutworms, leafrollers, diamondback moth), Coleoptera (e.g., cucumber beetles, flea beetles, Mexican bean beetle), Homoptera (e.g., aphids, leafhoppers), Hemiptera (e.g., plant bugs, stink bugs, lygus bugs), and Thysanoptera (e.g., thrips). Methomyl is particularly effective against Lepidopteran insects, on which it acts rapidly, but has little residual effect.

Oxamyl is sold by DuPont as the active ingredient in Vydate® insecticide/nematicide and used for control of numerous insect pests of agricultural crops including, but not limited to insects from the order Lepidoptera (e.g., pink bollworm), Coleoptera (e.g., boll weevil, flea beetle, Colorado potato beetle), Homoptera (e.g., green peach aphid, potato leafhopper, whitefly), Hemiptera (e.g., tarnished plant bug), nematodes such as from the genera Meloidogyne, Pratyletichus and Trichodorus, and mites such as from the genera Phyllocoptruta, Panonychus and Tetranychus. Oxamyl is particularly effective against nematode species, on which it acts rapidly but has little residual effect. Oxamyl is applied in soil treatments as well as foliar treatments, particularly for soil pests such as root nematodes.

Both methomyl and oxamyl are used to control certain foliar pests in cotton crops, and use of combinations of methomyl and oxamyl for this purpose have been reported. L. Antilla et al., 1998 Proceedings Beltwide Cotton Conferences, January 5-9, San Diego, Calif., Vol. 2, pp. 1206-1209 describe field tests involving over-the-top spray treatments of cotton plants with a mixture of 32 oz. of Lannate® and 32 oz. of Vydate® to control Lygus spp. (order Hemiptera) While some data presented might suggest that this mixture provided greater control than 32 oz. of Vydate® alone, the authors mention that in another test no significant difference was found, and moreover factors such as natural declines in adult insecticide levels can hamper attempts to establish true insecticide efficiency in such field tests. J. T. Ruscoe et al., 1997 Proceedings Beltwide Cotton Conferences, January 6-10, New Orleans, La., Vol. 2, pp. 888-891 report the effect on populations of Lygus lineolaris on transgenic BT cotton using a mixture of Vydate® C-LV at 0.25 lb ai/A and Lannate® LV at 0.22 lb ai/A, but do not report of the effects of these insecticides separately.

While methomyl and oxamyl are useful for controlling certain foliar phytophagous insect pests, including insects of the order Lepidoptera, alternatives to direct application to the pests and plant foliage may be desirable to reduce potential environmental (e.g., spray drift) hazards and minimize restricted entry intervals for field workers. However, alternative methods of application may not achieve sufficient efficacy. An alternative method of application providing surprisingly good control of insect pests using mixtures of methomyl and oxamyl has now been discovered.

### SUMMARY OF THE INVENTION

This invention pertains to a method for protecting a plant planted in a growing medium from a foliar insect pest comprising applying an insecticidally effective amount of a mixture comprising methomyl (methyl N-[[(methylamino)carbonyl]oxy]ethanimidothioate) and oxamyl (methyl 2-(dimethylamino)-N-[[(methylamino)carbonyl]oxy]-2-oxoethanimido-thioate) to the growing medium.

### DETAILED DESCRIPTION OF THE INVENTION

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “foliar” refers to leaves, stems, flowers, fruits and other parts of plants not covered by or immersed in the growing medium. “Growing medium” refers to the primarily solid or liquid medium in which plant roots grow. For crop plants grown in a field, the growing medium is typically soil containing varying amounts of sand, silt, clay and organic matter, but growing media can include any of a variety of processed and artificial media including water, rock wool, fiberglass, vermiculite, perlite, peat moss, bark, shredded coconut husks, etc. “Germination medium” refers to the primarily solid or liquid medium in which or on which seeds are germinated. Like the growing medium, the germination medium can also include varying amounts of sand, silt, clay, organic matter, water, rock wool, fiberglass, vermiculite, perlite, peat moss, bark, shredded coconut husks, etc. The germination medium of a plant grown from seed can be the same or different from the growing medium of the plant at time of application of the mixture comprising methomyl and oxamyl.

### EMBODIMENTS OF THE PRESENT INVENTION INCLUDE

### Embodiment 1

The method wherein the methomyl and oxamyl are applied simultaneously.

### Embodiment 2

The method wherein the methomyl is applied first and then oxamyl is applied.

### Embodiment 3

The method wherein the oxamyl is applied first and then methomyl is applied.

### Embodiment 4

The method wherein the methomyl and oxamyl are applied to the growing medium by a spot gun.

### Embodiment 5

The method wherein the methomyl and oxamyl are applied to the growing medium through an irrigation system.

### Embodiment 6

The method of Embodiment 5 wherein the irrigation system is drip irrigation.

### Embodiment 7

The method of Embodiment 5 wherein the irrigation system uses micro-sprinklers.

### Embodiment 8

The method wherein methomyl and oxamyl are applied by application of granules comprising the methomyl and oxamyl to the growing medium.

### Embodiment 9

The method wherein methomyl and oxamyl are applied by injection into the growing medium.

### Embodiment 10

The method wherein one or both of the methomyl and oxamyl are applied to the growing medium in a precursor form.

### Embodiment 11

The method of Embodiment 10 wherein the methomyl is applied as thiodicarb.

### Embodiment 12

The method wherein at least 80% of the methomyl and oxamyl is applied to the growing medium instead of plant foliage.

### Embodiment 13

The method of Embodiment 12 wherein at least 90% of the methomyl and oxamyl is applied to the growing medium instead of plant foliage.

### Embodiment 14

The method of Embodiment 13 wherein at least 95% of the methomyl and oxamyl is applied to the growing medium instead of plant foliage.

### Embodiment 15

The method of Embodiment 14 wherein at least 99% of the methomyl and oxamyl is applied to the growing medium instead of plant foliage.

### Embodiment 16

The method of Embodiment 15 wherein at least 99.9% of the methomyl and oxamyl is applied to the growing medium instead of plant foliage.

### Embodiment 17

The method wherein methomyl and oxamyl are applied in a weight ratio between about 1:1 and about 1:50.

### Embodiment 18

The method of Embodiment 17 wherein the weight ratio is between about 1:2 and about 1:35.

### Embodiment 19

The method of Embodiment 18 wherein the weight ratio is between about 1:3 and about 1:20.

### Embodiment 20

The method wherein the foliar insect pest is a species of the order Lepidoptera.

### Embodiment 21

The method of Embodiment 20 wherein the foliar insect pest is at least one of the species Helicoverpa zea, Heliothis virescenis, Spodoptera exigua and Trichoplusia iii.

### Embodiment 22

The method of Embodiment 21 wherein the foliar insect pest is Spodoptera exigua.

### Embodiment 23

The method of Embodiment 21 wherein the foliar insect pest is Heliotlhis virescens.

### Embodiment 24

The method of Embodiment 21 wherein the foliar insect pest is Trichoplusia ni.

### Embodiment 25

The method wherein the plant is in one of the families Asteraceae, Brassicaceae, Chenopodiaceae, Cucurbitaceae and Solanaceae.

### Embodiment 26

The method of Embodiment 25 wherein the plant is in the family Asteraceae.

### Embodiment 27

The method of Embodiment 26 wherein the plant is a Lactuca species.

### Embodiment 28

The method of Embodiment 27 wherein the plant is Lactuca sativa.

### Embodiment 29

The method of Embodiment 25 wherein the plant is in the family Brassicaceae.

### Embodiment 30

The method of Embodiment 29 wherein the plant is a Brassica species.

### Embodiment 31

The method of Embodiment 30 wherein the plant is Brassica oleracea.

### Embodiment 32

The method of Embodiment 25 wherein the plant is in the family Chenopodiaceae.

### Embodiment 33

The method of Embodiment 32 wherein the plant is a Beta species.

### Embodiment 34

The method of Embodiment 33 wherein the plant is Beta vulgarimi

### Embodiment 35

The method of Embodiment 25 wherein the plant is in the family Curcurbitaceae.

### Embodiment 36

The method of Embodiment 35 wherein the plant is a Cucumis, Cucurbita or Citrullus species.

### Embodiment 37

The method of Embodiment 36 wherein the plant is Cucumis sativus, Cucurbita maxima, Cucurbita moschata, Cucurbita pepo, Cucumis melo or Citrullus lanatus.

### Embodiment 38

The method of Embodiment 25 wherein the plant is in the family Solanaceae.

### Embodiment 39

The method of Embodiment 38 wherein the plant is a Solanum or Capsicum species.

### Embodiment 40

The method of Embodiment 39 wherein the plant is Solanum lycopersicuni, Capsicum annuum, Solanum melongena or Solanum tuberosum.

### Embodiment 41

The method of Embodiment 40 wherein the plant is Solanum lycopersicum.

### Embodiment 42

The method wherein the plant is grown from seed placed in or on a germination medium.

### Embodiment 43

The method of Embodiment 42 wherein the mixture comprising methomyl and oxamyl is applied to the growing medium of the plant no more than about 120 days from when (i.e. after) the seed of the plant was placed in or on the germination medium.

### Embodiment 44

The method of Embodiment 43 wherein the mixture comprising methomyl and oxamyl is applied to the growing medium of the plant no more than about 60 days from when (i.e. after) the seed of the plant was placed in or on the germination medium.

### Embodiment 45

The method of Embodiment 44 wherein the mixture comprising methomyl and oxamyl is applied to the growing medium of the plant no more than about 45 days from when (i.e. after) the seed of the plant was placed in or on the germination medium.

### Embodiment 46

The method of Embodiment 45 where the mixture comprising methomyl and oxamyl is applied to the growing medium of the plant no more than about 30 days from when (i.e. after) the seed of the plant was placed in or on the germination medium.

Embodiments of this invention can be combined in any manner. Combinations of the above Embodiments are illustrated by:

### Embodiment A

The method wherein the plant is a Lactuca, Brassica, Beta, Cucumis, Cucurbita, Citrullus, Solanum or Capsicum species.

### Embodiment B

The method of Embodiment A wherein the plant is Beta vulgaris, Brassica oleracea, Cucumis sativus, Cucurbita maxima, Cucurbita moschata, Cucurbita pepo, Cucumis melo, Citrullus lanatus, Solanum lycopersicum, Capsicum annuum, Lactuca sativa, Solanum melongena or Solanum tuberosum.

Combinations of methomyl and oxamyl when applied to the growing medium of a plant have now been found to not only protect plants from certain foliar insects but provide control which is substantially and surprisingly enhanced over the expected simply additive effect by said components.

Methomyl (Chemical Abstracts name: methyl N-[[(methylamino)carbonyl]oxy]-ethanimidothioate) has the molecular formula depicted as Formula I.

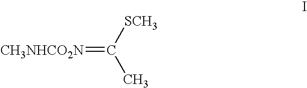

Although methomyl is most conveniently obtained as a commercial product, it can be prepared as described in U.S. Pat. No. 3,576,834. The synthesis involves the reaction of the hydroxamate of Formula 3 with methyl isocyanate (Formula 4) in an inert solvent such as dichloromethane.

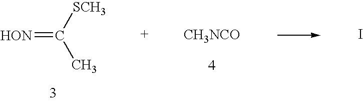

Oxamyl (Chemical Abstracts name: methyl 2-(dimethylamino)-N-[[(methylamino)-carbonyl]oxy]-2-oxoethanimidothioate) has the molecular formula depicted as Formula II.

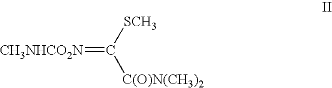

Although oxamyl is most conveniently obtained as a commercial product, it can be prepared as described in U.S. Pat. No. 3,658,870. The synthesis involves the reaction of the hydroxamate of Formula 5 with methyl isocyanate (Formula 4) in an inert solvent such as acetone.

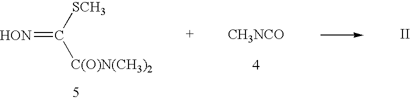

### Formulation/Utility

Methomyl and oxamyl according to the method of the present invention will generally be used in a formulation or a composition with an agriculturally suitable carrier comprising at least one of a liquid diluent, a solid diluent or a surfactant. Mixtures of methomyl and oxamyl can be formulated in two ways:
1. methomyl and oxamyl can be formulated separately and applied separately or applied simultaneously in an appropriate weight ratio, e.g., as a tank mix; or
2. methomyl and oxamyl can be formulated together in the weight ratios as defined herein.
   Therefore useful for the method of the present inventions are compositions comprising an insecticidally effective amount of methomyl and an agriculturally suitable carrier comprising at least one of a surfactant, a solid or a liquid diluent; an insecticidally effective amount of oxamyl and an agriculturally suitable carrier comprising at least one of a surfactant, a solid or liquid diluent; or an insecticidally effective amount of a mixture of methomyl and oxamyl and an agriculturally suitable carrier comprising at least one of a surfactant, a solid or liquid diluent. The agriculturally suitable carriers are selected consistent with the physical properties of the active ingredients, mode of application and environmental factors such as soil type, moisture and temperature. Useful formulations of methomyl and oxamyl, either separately or together, can be prepared in conventional ways. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient(s) can be (micro)encapsulated and further formed into a suspension or solid formulation; alternatively the entire formulation of active ingredient can be encapsulated (or “overcoated”). Encapsulation can control or delay release of the active ingredient(s). Sprayable formulations can be extended in suitable media and used at spray volumes from about one to several hundred liters per hectare. High-strength compositions are primarily used as intermediates for further formulation.

The formulations will typically contain effective amounts of active ingredient(s), diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders. | | | |
| Suspensions, Emulsions, | 1-50 | 40-99 | 0-50 |
| Solutions (including | | | |
| Emulsifiable Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, glycerol esters, polyoxyethylene/polyoxypropylene block copolymers, and alkylpolyglycosides where the number of glucose units, referred to as degree of polymerization (D.P.), can range from 1 to 3 and the alkyl units can range from C₆ to C₁₄ (see Pure and Applied Chemistry 72, 1255-1264). Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, glycerine, triacetine, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, acetates such as hexyl acetate, heptyl acetate and octyl acetate, and alcohols such as methanol, cyclohexanol, decanol, benzyl and tetrahydrofurfuryl alcohol.

Useful formulations of this invention may also contain materials well known to those skilled in the art as formulation aids such as antifoams, film formers and dyes. Antifoams can include water dispersible liquids comprising polyorganosiloxanes like Rhodorsil® 416. The film formers can include polyvinyl acetates, polyvinyl acetate copolymers, polyvinylpyrrolidone-vinyl acetate copolymer, polyvinyl alcohols, polyvinyl alcohol copolymers and waxes. Dyes can include water dispersible liquid colorant compositions like Pro-lzed® Colorant Red. One skilled in the art will appreciate that this is a non-exhaustive list of formulation aids. Suitable examples of formulation aids include those listed herein and those listed in McCutcheon's 2001, Volume 2: Functional Materials published by MC Publishing Company and PCT Publication WO 03/024222.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, December 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways.

### EXAMPLE A

Wettable Powder

| | |
|---|---|
| methomyl | 13.7% |
| oxamyl | 51.3% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### EXAMPLE B

Granule

| | |
|---|---|
| methomyl | 4.3% |
| oxamyl | 5.7% |
| attapulgite granules (low volatile matter, | 90.0%. |
| 0.71/0.30 mm; U.S.S. No. 25-50 sieves) | |

### EXAMPLE C

Extruded Pellet

| | |
|---|---|
| methomyl | 6.2% |
| oxamyl | 18.8% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE D

Emulsifiable Concentrate

| | |
|---|---|
| methomyl | 0.8% |
| oxamyl | 19.2% |
| blend of oil soluble sulfonates | 10.0% |
| and polyoxyethylene ethers | |
| isophorone | 70.0%. |

The present invention pertains to a method for controlling foliar insect phytophagous insects by applying to the below ground portions of the plant an effective amount of a mixture comprising methomyl and oxamyl. Furthermore, a separate composition comprising methomyl and a composition comprising oxamyl can be combined as a physical mixture prior to application, e.g., a tank mix, and applied simultaneously. Alternatively, insecticidal compositions containing only a composition of only one of methomyl and oxamyl can be applied followed by application of a composition of the other of methomyl and oxamyl. The methomyl and oxamyl can be applied to the soil surface or below the soil surface so that they reach by diffusion and/or flow the root zone of the plants to be protected. Application methods include spot-gun application, chemigation (i.e. application through an irrigation system) through drip irrigation or using micro-sprinklers, injection of liquid compositions below the soil surface, and soil application of granules. Spot-gun applicators are hand-held metered volume dispensers, typically comprising an adjustable graduated cylinder or syringe operated by squeezing a handle. Some of the application methods according to this invention such a spot-gun application and micro-sprinklers may result in methomyl and oxamyl being applied to a portion of the above ground portion of the plant (i.e. foliage) as well as the growing medium. Of note are: a method wherein at least 80% of each of methomyl and oxamyl is applied to the growing medium instead of the foliage, a method wherein at least 90% of each of methomyl and oxamyl is applied to the growing medium instead of the foliage, a method wherein at least 95% of each of methomyl and oxamyl is applied to the growing medium instead of the foliage, a method wherein at least 99% of each of methomyl and oxamyl is applied to the growing medium instead of the foliage, a method wherein at least 99.9% of each of methomyl and oxamyl are applied to the growing medium instead of the foliage.

The method of the present invention is useful for protecting plants from and controlling a wide range of foliar insect pests including larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis ipsilont Hufnagel), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Anzyelois transitella Walker); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck)); and many other economically important lepidoptera (e.g., diamondback moth (Plutella xylostella Linnaeus), pink bollworm (Pectinophora gossypiella Saunders), gypsy moth (Lymantria dispar Linnaeus)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), rice weevil (Sitophilus oryzae Linnaeus)); flea beetles, cucumber beetles, leaf beetles, potato beetles, and leafminers in the family Chrysomelidae (e.g., Colorado potato beetle (Leptinotarsa decemlineata Say); Mexican bean beetle (Epilachna varivestis Mulsant) in the family Coccinellidae; chafers and other beetles from the family Scaribaeidae (e.g., Japanese beetle (Popillia japonica Newman) and European chafer (Rhizotrogus majalis Razoumowsky)); bark beetles from the family Scolytidae; adults and nymphs of the orders Hemiptera and Homoptera such as, plant bugs (e.g., tarnished plant bug (Lygus lineolaris (Palisot de Beauvois)) from the family Miridae, leafhoppers (e.g. Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae squash bugs from the family Coreidae, and red bugs and cotton stainers from the family Pyrrhocoridae; and adults and immatures of the order Thysanoptera including onion thrips (Thrips tabaci Lindeman) and other foliar feeding thrips.

Lepidopterous insects are severe pests of many field crops, vegetables, greenhouse crops, fruit trees and vines. Control of these insects is essential for quality crops and high yields. The method of the present invention is particularly efficacious in protecting plants from and controlling insect pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenee (rice leaf roller), Cydia pomonella Linnaeus (codling moth), Earias insulana Boisduval (spiny bollworm), Earias vittella Fabricius (spotted bollworm), Helicoveipa armigera Hübner (American bollworm), Helicoveipa zea Boddie (corn earworm), Heliothis virescens Fabricius (tobacco budworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamondback moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)). Of particular note is protection from and control of Helicoveipa zea, Spodoptera exigua and Trichoplusia ni.

The method of the present invention is useful for protecting a broad range of plants vulnerable to foliar insect pests. Plants benefiting from the protection provided by the present method include both herbaceous plants and woody plants. As the method entails absorption of methomyl and oxamyl by roots and translocation to foliage, the method provides particularly rapid and effective protection of plants adapted to mesic to moist soils and growing in environments promoting transpiration of moisture from their leaves, thus drawing water and dissolved solutes from roots to foliage.

Illustrative of the wide variety of plants that can be protected from insect pests by the method of the present invention are fruit trees such as plant species in the family Rosaceae including pome fruits (e.g., apple (Malus pumila P. Mill.), pear (Pyrus cominunis L.)) and stone fruits (e.g., cherry (Prunus species such as P. avium (L.) L. and P. cerasus L.), apricot (Prunus armeniaca L.), almond (Prunus dulcis (P. Mill) D. A. Webber), peach (Prunus persica (L.), nectarine (Prunus persica (L.) Batsch var. nucipersica (Suckow) C. Schneider), plum (Prunus domestica L.)), in the family Rutaceae (i.e. citrus, including orange (Citrus sinensis (L.) Osbeck, tangerine (Citrus reticulata Blanco), lemon (Citrus limon (L.) Burm. f.), lime (Citrus aurantifolia (Christm.) Swingle), pummelo (Citrus maxima (Burm. f.) Merr.) and grapefruit (Citrus maxima x sinensis)), in the family Sapindaceae (e.g., longan (Dimocarpus longan Lour.), rambutan (Nephelium lappaceum L.), pulasan (Nephelium mutabile Blume), lychee (Litchi chineisis Sonn.)), in the family Anacardiaceae (e.g., mango (Mangifera indica L.)), in the family Bombacaceae (e.g., durian (Durio zibethinus Murray)), in the family Moraceae (e.g., jackfruit (e.g., Artocarpus heterophyllus Lam.)), and in the family Myrtaceae (e.g., rose apple (Syzygium jainbos (L.) Alston)). Also illustrative are shrubs in the family Rubiaceae such as coffee (e.g., Coffea arabica L., Coffea canephora Pierre ex Froehner)) and the family Malvaceae such as cotton (e.g., Gossypium hirsutum L., Gossypium barbadense L.), vines in the family Vitaceae such as grape (e.g., Vitis labrusca L., Vitis vinifera L.) and grasses in the family Poaceae (e.g., maize (Zea mays L.), sugarcane (Saccharum officinarum L.)). As insect protection provided by the present method involves translocation of methomyl and oxamyl from roots to foliage, the method is more quickly effective in protecting seedlings and mature plants of small to moderate size. Mature plants of small to moderate size are generally herbaceous but can include small shrubs. Accordingly, the method is particularly valuable for protecting plants in the families Asteraceae, Brassicaceae (alternatively named Cruciferaceae), Chenopodiaceae, Cucurbitaceae and Solanaceae. Asteraceae includes crop plants such as lettuce (Lactuca sativa L.). Brassicaceae includes crop plants such as Brassica species including cabbage, cauliflower, broccoli and brussels sprouts (all Brassica oleracea L.). Chenopodiaceae includes crop plants such as garden beets and sugarbeets (both Beta vulgaris L.). Cucurbitaceae includes crop plants including Cucumis, Cucurbita and Citrullus species such as cucumbers (e.g., garden cucumber (Cucumis sativus L.)), squash (e.g., winter squash (Cucurbita maxima Duchesne), crookneck squash (Cucurbita moschata (Duchesne ex Lam.) Duchesne ex Poir.), pumpkin (Cucurbita pepo L.)) and melons (e.g., cantaloupe and honeydew (Cucumis melo L.), watermelon (Citrullus lanatus (Thunb.) Matsumura & Nakai)). Solanaceae includes crop plants including Solanum and Capsicum species such as tomato (Solanum lycopersicum L.), Cayenne and other garden peppers (Capsicum annuum L.), eggplant (Solanum melongena L.) and Irish potato (Solanum tuberosum L.).

Typically the methomyl and oxamyl are applied to the growing medium according to the present method at about the same time or after a seed of a plant, a seedling or an older (i.e. more mature) plant is placed in the growing medium (e.g., “seeded”, “planted”, “transplanted). However, as protecting a plant according to the present method requires only that methomyl and oxamyl be present in the growing medium, methomyl and oxamyl can be applied to the growing medium before the seed, seedling or older plant is placed in the growing medium. Because both methomyl and oxamyl degrade on prolonged contact with most growing media, the methomyl and oxamyl are most advantageously applied to the growing medium no more than about a week before and preferably no more than about two days before the seed, seeding or older plant is placed in the growing medium.

The method can be used to protect mature plants, but as the method involves translocation from roots to the foliage to be protected it is more quickly effective for protecting plants before they have reached adult size. Therefore a preferred embodiment of the present invention relates to the method wherein the plant was grown from seed and is still young (e.g., a seedling) at the time of application. Por such application of methomyl and oxamyl, the growing medium to which methomyl and oxamyl are applied is the germination medium if the plant has not been transplanted. If the plant is transplanted the growing medium to which methomyl and oxamyl are applied is the medium in which the plant is or will be growing. Preferably the methomyl and oxamyl are applied to the growing medium no more than about 60 days from when (i.e. after) the seed of the plant was placed in or on germination medium, more preferably no more than about 45 days, most preferably no more than about 30 days. However, the methomyl and oxamyl can be applied to the growing medium 120 days from when the seed of the plant was placed in or on the germination medium or even much longer, as for perennial crops, including shrubs and trees.

To maintain protection as plants grow and to obtain the greatest protection of large plants repeated applications of methomyl and oxamyl to the growing medium can be beneficial. Preferably most of the plant roots are located in the region of the growing medium to which the mixture of methomyl and oxamyl is applied; for plants with extensive deep root systems (e.g., trees) injection of the methomyl and oxamyl into the root zone can be advantageous.

In the method of the present invention methomyl and/or oxamyl can also be further mixed with one or more other insecticides, fungicides, nematocides, bactericides, acaricides, semiochemicals, repellents, attractants, pheromones, feeding stimulants or other biologically active compounds to form a multi-component pesticide giving an even broader spectrum of agricultural protection. Examples of such agricultural protectants with which compounds of this invention can be formulated are: insecticides such as acetamiprid, carbaryl, carbofuran, chlorpyrifos, chlorpyrifos-methyl, clothianidin, diazinon, dinotefuran, fipronil, flonicamid, imidacloprid, novaluron, rotenone, spinosad, thiacloprid, thiomethoxam and thiodicarb; fungicides such as amisulbrom, azoxystrobin, benomyl, bitertanol, boscalid, captan, carbendazim, carboxin, chloroneb, cymoxanil, cyproconazole, cyprodinil, difenoconazole, diniconazole, diniconazole-M, edifenphos, epoxyconazole, etridiazole, fenarimol, fenbuconazole, fenfuram, fenpropimorph, fluazinam, fludioxonil, fluquinconazole, flusilazole, flutolanil, flutriafol, folpet, fosetyl-aluminum, fuberidazole, furalaxyl, hexaconazole, hymexazol, ipconazole, iprobenfos, iprodione, kresoxim-methyl, mancozeb, maneb, mepronil, metalaxyl, metalaxyl-M, metconazole, myclobutanil, oxadixyl, penconazole, penthiopyrad, probenazole, prochloraz, propiconazole, prothioconazole, pyrifenox, silthiofam, simeconazole, tebuconazole, tetraconazole, thiabendazole, thiophanate-methyl, thiram, tricyclazole, triticonazole and uniconazole; nematocides such as abamectin, aldoxycarb and fenamiphos; bactericides such as streptomycin; and biological agents such as entomopathogenic bacteria, virus and fungi.

In certain instances, combinations with other insecticides having a similar spectrum of control but a different mode of action will be particularly advantageous for resistance management.

Rates of application for methomyl and oxamyl according to the method of this invention can be influenced by many factors of the environment and should be determined under actual use conditions. Plants can normally be protected from foliar insect pests when the growing medium in their root zone (i.e. portion of growing medium from which the plant roots obtain moisture and nutrients) is treated at a rate of generally from about 200 g/ha to about 6000 g/ha (corresponding to the surface area of the root zone) per application of aggregate active ingredient, more typically about 400 g/ha to about 4000 g/ha, and most typically from about 600 g/ha to about 2000 g/ha. Aggregate active ingredient is defined as the total combined weight of active ingredients. Typically the weight ratio of methomyl to oxamyl is between about 1:1 to about 1:50, preferably between about 1:2 and about 1:35, and more preferably between about 1:3 and about 1:20.

One skilled in the art appreciates that one or both of methomyl and oxamyl can be applied to the growing medium as a precursor substance that is converted to methomyl or oxamyl on exposure to the environment of the growing medium, which typically comprises water, oxygen and microbes, as well as exposure to light on the surface of the growing medium. Of particular note as a precursor to methomyl is thiodicarb. One skilled in the art recognizes that the corresponding application rates and ratios for precursors of methomyl and/or oxamyl can be easily calculated from the relative molecular weights of the precursors and methomyl and/or oxamyl and the application rates and ratios for methomyl and oxamyl described herein.

As the method of the present invention involves application of methomyl and oxamyl to the growing medium to protect plants against insect pests on foliage, which is above the growing medium, the method requires not only absorption of methomyl and oxamyl by the roots but systemic translocation of methomyl and oxamyl to the above ground portions of plants on which foliar insects feed. Not only have mixtures of methomyl and oxamyl been discovered to be absorbed and systematically translocated in sufficient amount to protect plants from foliar insects, but even more surprisingly with application of methomyl and oxamyl to the growing medium a synergistic effect is observed. Due to the synergism, methomyl and oxamyl can provide substantially more foliar insect control from application to the growing medium than would be expected from additive effects. The mechanism of this synergism is unknown, but without being bound to any one particular theory, one possibility is that unexpectedly methomyl and oxamyl improve each others' root uptake and systemic translocation.

The pronounced synergism manifested by mixtures of methomyl and oxamyl allows a substantial reduction in the application rates of one or both of these active ingredients, while maintaining good insecticidal efficacy. The greater than expected effect persists for days after application, facilitating rapid knockdown and mortality. Decreasing application rates reduces treatment cost to the farmer and also eases the burden on the environment both from manufacturing waste and crop protection chemical residues.

The presence of a synergistic effect between two active ingredients can be established with the aid of the Colby equation (see Colby, S. R., “Calculating Synergistic and Antagonistic Responses of Herbicide Combinations”, Weeds 1967, 15, 20-22):

$$p = A + B - [ \frac{A \times B}{100} ]$$

Using the method of Colby, the presence of a synergistic interaction between two active ingredients is established by first calculating the predicted activity, p, of the mixture based on activities of the two components applied alone. In the equation above, A is the insecticidal activity in percentage control of one component applied alone at rate x. The B term is the insecticidal activity in percentage control of the second component applied at rate y. The equation calculates p, the predicted insecticidal activity of the mixture of A at rate x with B at rate y if their effects are strictly additive and no interaction has occurred. If the experimentally established effect of the mixture is greater than the predicted activity, p, synergism is present.

The following Test Example demonstrates the method of the present invention and provides experimental evidence for synergy between methomyl and oxamyl in controlling a Lepidoptera species, Spodoptera exigua. The insect control protection afforded by the present method is not limited, however, to this species.

### TEST A

For evaluating control of beet armyworm (Spodoptera exigua), methomyl was in liquid formulation as Lannate® LV (29% of active ingredient). Oxamyl was in liquid formulation as Vydate® L (24% active ingredient).

The test compounds were dissolved in water. Enough water was added to make 29 ppm of active ingredient for Lannate® LV and 500 ppm of active ingredient for Vydate® L. To obtain the desired mixture concentrations of each compound, twice the desired concentration of each of the two mixture partner compounds were mixed together in equal volumes.

Diluted solutions (50 mL) of the test compounds were applied to the soil surface of five-week-old tomato plants at the desired concentration, corresponding to 47 g a.i./ha (g active ingredient/hectare) of methomyl and 807 g a.i./ha of oxamyl. The plants were maintained in a greenhouse for 24 h. From each plant, leaves were excised, cut into pieces, and placed singly into 5.5 cm-by-3.5 cm cell of a sixteen-cell plastic tray. Each cell contained solidified agar (3 to 5 mL) to prevent desiccation. A single 4-day old insect larva was placed in each cell, with one tray per treatment. Trays were held in a growth chamber at 25° C., 16-hour light/8-hour dark photoperiod, 60% relative humidity for 4 days. The test was evaluated visually at 96 h for % of insect mortality; the results are listed in Table A.

TABLE A
Control of Spodoptera exigua by
Soil Application of Methomyl and Oxamyl

| | Rate | % mortality |
|---|---|---|
| Compound | (g a.i./ha) | (observed) |
| Methomyl | 47 | 44 |
| Oxamyl | 807 | 0 |
| Methomyl + Oxamyl | 47 + 807 | 72 |
| Untreated | 0 | 0 |

Although oxamyl at 807 g a.i. caused no mortality, in combination with methomyl at 47 g a.i./ha it surprisingly increased percent mortality of Spodoptera exigua from 44% to 72%, as shown in Table A.

### TEST B

For evaluating control of cabbage looper (Trichoplusia ni) and tobacco budworm (Heliothis virescens), methomyl was in liquid formulation as Lannate® LV (29% of active ingredient). Oxamyl was in liquid formulation as Vydate® L (24% of active ingredient).

The test compounds were dissolved in water. Enough water was added to make 57 ppm of the Lannate® LV and 250 and 500 ppm of active ingredient for Vydate® L. To obtain the desired mixture concentrations of each compound, twice the desired concentration of each of the two mixture compounds were mixed together in equal volumes.

For the cabbage looper trial, diluted solutions (50 mL) of the test compounds were applied to the soil surface of five-week-old cabbage plants at the desired concentrations, corresponding to 135 g a.i./ha (g active ingredient/hectare) of methomyl and 404 and 807 g a.i./ha of oxamyl. For the tobacco budworm trial, diluted solutions (50 mL) of the test compounds were applied to the soil surface of five-week-old tomato plants at the desired concentrations, corresponding to 92 g a.i./ha (g active ingredient/hectare) of methomyl and 404 and 807 g a.i./ha of oxamyl. The plants were maintained in a greenhouse for 24 h. From each plant, leaves were excised, cut into pieces, and placed singly into 5.5 cm-by-3.5 cm cell of a sixteen-cell plastic tray. Each cell contained solidified agar (3 to 5 mL) to prevent desiccation. A single 4-day old insect larva was placed in each cell, with two trays per treatment. Trays were held in a growth chamber at 25° C., 16-hour light/8-hour dark photoperiod, 60% relative humidity for 4 days. The test was evaluated visually at 96 h for percent insect mortality; the results are listed in Tables B1 and B2.

TABLE B1
Control of Trichoplusia ni by Soil Application of Methomyl and Oxamyl

| | Rate | % Mortality | |
|---|---|---|---|
| Compound | (g a.i./ha) | (Observed) | (Expected*) |
| Methomyl | 135 | 75 | — |
| Oxamyl | 404 | 16 | — |
| | 807 | 38 | — |
| Methomyl + Oxamyl | 135 + 404 | 91 | 79 |
| | 135 + 807 | 91 | 84 |
| Untreated | 0 | 0 | — |

*Expected from Colby Equation.

TABLE B2
Control of Heliothis virescens by
Soil Application of Methomyl and Oxamyl

| | Rate | % Mortality | |
|---|---|---|---|
| Compound | (g a.i./ha) | (Observed) | (Expected*) |
| Methomyl | 92 | 41 | — |
| Oxamyl | 404 | 6 | — |
| | 807 | 13 | — |
| Methomyl + Oxamyl | 92 + 404 | 50 | 44 |
| | 92 + 807 | 63 | 48 |
| Untreated | 0 | 0 | — |

*Expected from Colby Equation.

As can be seen from Tables B1 and B2, soil application of mixtures of methomyl and oxamyl provided surprisingly better mortality of Trichoplusia ni and Heliothis virescens than expected from the effects of methomyl and oxamyl applied alone.

What is claimed is:

1. A method for protecting a plant planted in a growing medium from a foliar insect pest comprising applying an insecticidally effective amount of a mixture comprising methomyl and oxamyl to the growing medium.

2. The method of claim 1 wherein the methomyl is applied as thiodicarb.

3. The method of claim 1 wherein the methomyl and oxamyl are applied simultaneously.

4. The method of claim 1 wherein the methomyl and oxamyl are applied to the growing medium through an irrigation system.

5. The method of claim 1 wherein at least 80% of the methomyl and oxamyl is applied to the growing medium instead of plant foliage.

6. The method of claim 5 wherein at least 95% of the methomyl and oxamyl is applied to the growing medium instead of plant foliage.

7. The method of claim 1 wherein the foliar insect pest is a species of the order Lepidoptera.

8. The method of claim 7 wherein the foliar insect pest is at least one of Helicoverpa zea, Heliothis virescens, Spodoptera exigua and Trichoplusia ni.

9. The method of claim 1 wherein the plant is in one of the families Asteraceae, Brassicaceae, Chenopodiaceae, Cucurbitaceae and Solanaceae.

10. The method of claim 9 wherein the plant is a Lactuca, Brassica, Beta, Cucumis, Cucurbita, Citrullus, Solanum or Capsicum species.
